(19) United States
(12) Patent Application Publication
(10) Pub. No.: US 2006/0120774 A1
(43) Pub. Date: Jun. 8, 2006

(54) Transfer unit and image forming apparatus

(75) Inventor: Jong-Tae Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/235,082

(22) Filed: Sep. 27, 2005

(30) Foreign Application Priority Data
Dec. 8, 2004 (KR) 2004-102765

(51) Int. Cl. G03G 15/01

(52) U.S. Cl. 399/302

(57) ABSTRACT

An image forming apparatus having a transfer unit is provided. The transfer unit includes a transfer belt which is wound, for example, in a circular shape. A belt support unit supports and fixes edges of the transfer belt and rotates along with the transfer belt.

### CROSS-REFERENCE TO RELATED APPLICATIONS

This application claims the benefit under 35 U.S.C. 119(a) of Korean Patent Application No. 2004-102765, filed Dec. 8, 2004, the entire disclosure of which is hereby incorporated by reference.

### BACKGROUND OF THE INVENTION

1. Field of the Invention

The present invention relates to an image forming apparatus. More particularly, the present invention relates to an image forming apparatus having a transfer unit.

2. Description of the Related Art

In general, an image forming apparatus can be classified into a monochromatic image forming apparatus for printing single color images and a color image forming apparatus for printing multiple colored images.

The color image forming apparatus forms a color image using magenta (M), cyan (C), yellow (Y), and black (K) developers.

In the color image forming apparatuses, electrostatic latent images are formed on photosensitive bodies charged with predetermined potentials by charging units via laser light emitted from laser scanning units. The electrostatic latent images are developed with developers and then transferred as visible images to a printing medium supplied. In the case of the color image forming apparatus, the electrostatic latent images on the photosensitive bodies are developed with developers of respective colors and then overlapped and transferred to an intermediate transfer medium such as an intermediate transfer belt (ITB). The color image overlapped on the intermediate transfer medium is transferred to the printing medium. The printing medium undergoes a series of fixing processes and is discharged from the image forming apparatus.

The developers are inks such as powdered toners and liquid carriers having predetermined colors and electrical characteristics. The inks are supplied to a developing unit through an additional ink cartridge so as to develop the electrostatic latent images on the photosensitive bodies.

In the above color image forming apparatus, a transfer belt supported by a plurality of rollers is generally used as the intermediate transfer medium to which the images with respective colors are overlapped and transferred. The transfer belt is generally supported by three rollers, such as a drive roller, an idle roller, and a tension roller.

When the drive roller rotates, the transfer belt rotates due to a frictional force between the drive roller and the transfer belt. Additionally, the tension roller and idle roller provide a predetermined tension to the transfer belt to support the transfer roller so as to tighten the transfer belt.

However, the transfer belt has drawbacks. For example, the transfer belt may slip if a frictional force between the drive roller and the transfer belt declines. Moreover, a linear velocity of the transfer belt may vary due to deviations in transfer belt thickness and drive roller tolerances. When the transfer belt shrinks and expands due to temperature variation, the drive roller may have difficulty actively managing the shrinkage and expansion of the transfer belt.

The rotation of the drive roller, the idle roller, the tension roller and the transfer belt may be performed simultaneously or independently. Thus, it is often difficult to calculate the linear velocity of the transfer belt.

Accordingly, it is relatively difficult to accurately drive and control the transfer belt. Consequently, it is difficult to minimize registration errors of color images overlapping on the transfer belt.

Accordingly, there is a need for an improved transfer belt mechanism that minimizes variations in linear velocity due to temperature variations and manufacturing tolerances.

### SUMMARY OF THE INVENTION

Embodiments of the present invention solve at least the above problems and/or disadvantages and provide at least the advantages described below. Accordingly, an aspect of the present invention is to provide a transfer unit having an improved structure so as to be easily driven and controlled to reduce errors and an image forming apparatus having the transfer unit.

According to an aspect of the present invention, there is provided a transfer unit of an image forming apparatus for receiving an image from at least one or more photosensitive bodies and transferring the image to a printing medium. The transfer unit includes a substantially annular transfer belt having first and second edges, a belt support unit configured to support and fix respective edges of the transfer belt and to rotate along with the transfer belt.

The belt support unit preferably includes a pair of spaced apart support wheels to which the edges of the transfer belt are fixed and a support shaft rotatably supporting the pair of support wheels.

The transfer unit preferably also includes at least one or more backup rollers which rotatably contact a rear surface of the transfer belt and a roller support supported by the belt support unit so as to support the backup rollers.

The roller support preferably comprises one end connected to the support shaft and another end which supports the backup rollers so that the backup rollers rotate.

Gears may be provided on outer circumferential surfaces of the pair of support wheels and supplied with power from an external source. Bearings may be connected with the outer circumferential surfaces of the pair of support wheels.

Bearings may be arranged between the support wheels and the support shaft. Combining holes through which combiners are connected with the pair of support wheels pass are arranged proximate to one of the edges of the transfer belt.

According to another aspect of the present invention, there is provided an image forming apparatus which includes a transfer unit comprising a transfer belt for receiving an image from a photosensitive body and transferring the image to a printing medium and a belt support unit for supporting first and second edges of the transfer belt so as to rotate along with the transfer belt and a driver which rotates and drives the support unit.

The belt support unit preferably includes a pair of support wheels to which the edges of the transfer belt are connected and which are spaced apart from each other. A support shaft rotatably supports the pair of support wheels.

The transfer unit preferably includes at least one or more backup rollers which rotatably contact a rear surface of the transfer belt and a roller support connected to the belt support unit so as to support the backup rollers so that the backup rollers rotate.

The backup rollers may include transfer rollers arranged so as to face the photosensitive body and backup rollers facing transfer rollers to transfer an image from the transfer belt to the printing medium.

The support wheels preferably include disc-shaped wheel bodies combined with the support shaft, support ribs formed on outer sides of the wheel bodies which connect one of the edges of the transfer belt, and gears arranged adjacent to the support ribs so as to receive power from the driver.

The driver preferably includes a pair of drive gears rotatably connected to the support wheels so as to be driven and a drive motor which provides power to the drive gears.

The driver preferably further includes a rotation shaft rotatably supporting the drive gears so as to rotate along with the drive gears and a connecting gear arranged proximate to a center of the rotation shaft so as to be positioned between the drive gears and connected to the drive motor to receive power.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic vertical cross-sectional view of an image forming apparatus according to an embodiment of the present invention;

FIG. 2 is a schematic horizontal cross-sectional view of the image forming apparatus shown in FIG. 1; and

FIG. 3 is a perspective view of the image forming apparatus shown in FIG. 1.

Throughout the drawings, the same drawing reference numerals will be understood to refer to the same elements, features, and structures.

### DETAILED DESCRIPTION OF EXEMPLARY EMBODIMENT

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness. I.

Hereinafter, an image forming apparatus according to an exemplary embodiment of the present invention will be described in detail with reference to the attached drawings.

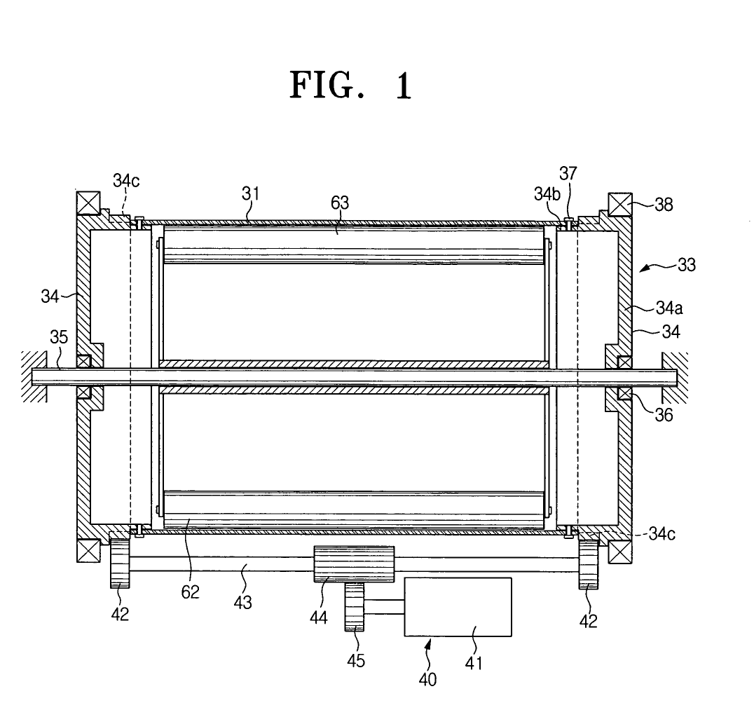

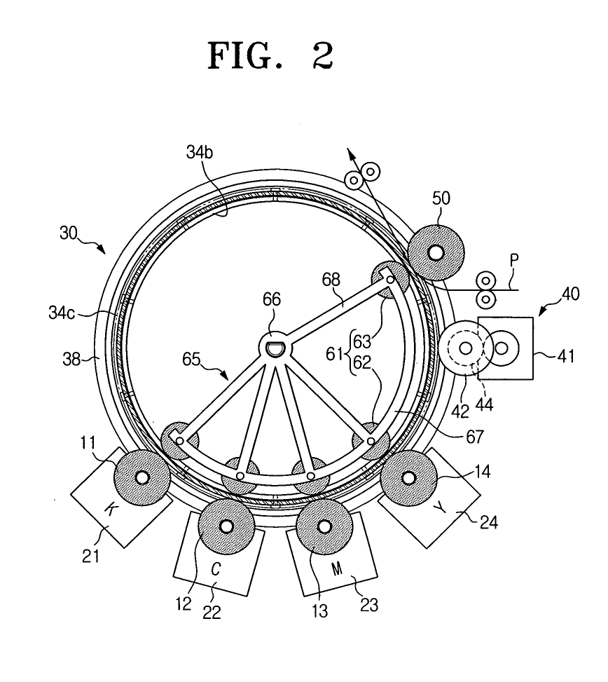

Referring to FIGS. 1 and 2, an image forming apparatus according to an exemplary embodiment of the present invention includes photosensitive bodies 11, 12, 13, and 14 for respective colors, such as black, cyan, magenta, and yellow (K, C, M, and Y), a transfer unit 30 which transfers images of respective colors formed on the photosensitive bodies 11, 12, 13, and 14 to a printing medium P, a driver 40 to drive the transfer unit 30, and a T roller 50.

The photosensitive bodies 11, 12, 13, and 14 are preferably disposed along a rotational direction of the transfer unit 30 so as to form K, C, M, and Y color images. Surfaces of the photosensitive bodies 11, 12, 13, and 14 are charged with predetermined potentials by charging units (not shown). Electrostatic latent images are formed on the surfaces of the photosensitive bodies 11, 12, 13, and 14 via laser light emitted from laser scanning units (not shown).

Developing units 21, 22, 23, and 24 for the respective K, C, M, and Y colors are preferably installed under the photosensitive bodies 11, 12, 13, and 14. The developing units 21, 22, 23, and 24 develop the electrostatic images formed on the photosensitive bodies with K, C, M, and Y color developers to form K, C, M, and Y color images. A developing method which forms the K, C, M, and Y color images on the photosensitive bodies 11, 12, 13, and 14 is the same as a developing process of a general color printer, and thus its detailed description will be omitted for clarity and conciseness.

The transfer unit 30 includes a transfer belt 31 and a belt support unit 33 supporting the transfer belt 31.

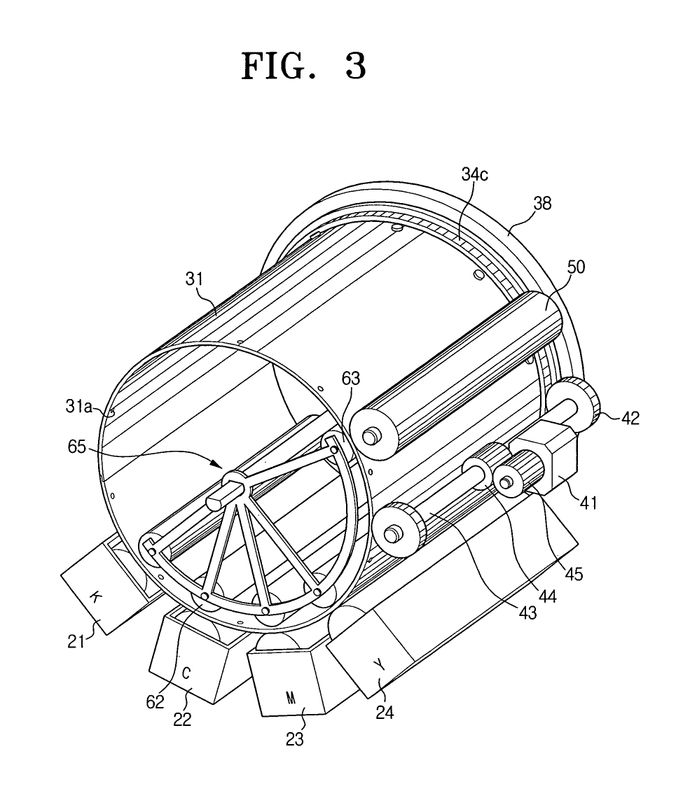

As shown in FIG. 3, both ends of the transfer belt 31 are integrally connected to each other to form a substantially cylindrical shape. Connecting holes 31a are formed at predetermined distances from one another at both edges of the transfer belt 31.

The belt support unit 33 includes a pair of support wheels 34 and a support shaft 35 rotatably supporting the pair of support wheels 34.

The pair of support wheels 34 support the edges of the transfer belt 31 so as to rotate with the transfer belt 31. The pair of support wheels 34 comprise disc-shaped wheel bodies 34a, support ribs 34b formed on outer sides of the wheel bodies 34a, and gears 34c. The support shaft 35 is preferably arranged coaxially with the centers of the wheel bodies 34a so as to rotate with respect to the common axis. Bearings 36 may be installed between the wheel bodies 34a and the support shaft 35. The support ribs 34b are preferably annularly shaped and arranged on the wheel bodies 34a. A rear surface of the transfer belt 31 contacts outer circumferential surfaces of the support ribs 34b. The transfer belt 31 may be fixed or integrally attached to the support ribs 34b by combiners 37 such as screws, stud pins, or the like. Preferably, the combiners 37 are connected with the support ribs 34b through the connecting holes 31a of the transfer belt 31. The gears 34c are arranged on outer circumferential surfaces of the wheel bodies 34a. The gears 34c receive power from the driver 40. The gears 34c have greater radiuses than the support ribs 34b.

Bearings 38 are preferably installed on outer circumferential surfaces of the support wheels 34. The bearings 38 support the transfer unit 30 so that the transfer unit 30 rotates when the transfer unit 30 is mounted on the main body of the image forming apparatus. In other words, when the transfer unit 30 is mounted inside the main body of the image forming apparatus, the transfer belt 31 rotates with the support unit 33 with respect to the support shaft 35.

The transfer unit 30 includes a plurality of backup rollers 61 which rotatably contact the rear surface of the transfer belt 31 and a roller support 65 supporting the plurality of backup rollers 61.

The plurality of backup rollers 61 include T1 rollers 62 for respective K, C, M, and Y colors and T2 backup rollers 63 so as to face the photosensitive bodies 11, 12, 13, and 14. Here, a T2 transfer roller 50 is provided to rotate in contact with the transfer belt 31 so as to transfer an image from the transfer belt 31 to the printing medium P. The T2 backup rollers 62 are arranged to face the T2 transfer roller 50 so as to rotate in contact with the rear surface of the transfer belt 31.

The roller support 65 is connected to the support unit 33 so as to support the backup rollers 61 so that the backup rollers 61 rotate. In detail, an end of the roller support 65 is fixed to the support shaft 35, and an other end of the roller support 65 supports the backup rollers 61 so that the backup rollers 61 rotate. For this purpose, the roller support 65 includes a shaft part 66 fixed or integrally connected to the support shaft 35, a support bracket 68 to which the backup rollers 61 are rotatably connected, and a connecting rib 68 connecting the support bracket 67 and the shaft part 66. The shaft part 66, the support bracket 67, and the connecting rib 68 may form a single body.

According to the above-described structure, the support shaft 35, the backup rollers 61, and the roller support 65 do not move based on a rotational center of the transfer belt 31. Also, only the transfer belt 31 and the support unit 33 rotate around the support shaft 35 so that the photosensitive bodies 11, 12, 13, and 14 overlap and transfer color images on and/or to the transfer belt 31 and the support unit 33.

The driver 40 includes a drive motor 41, a pair of drive gears 42 connected to the gears 34c of the support wheels 34, a rotation shaft 43 connecting the drive gears 42, and a connecting gear 44 provided at the rotation shaft 43. The pair of drive gears 42 are connected to each other by the rotation shaft 43 so as to rotate simultaneously. Thus, the pair of drive gears 42 simultaneously transmit a rotation power to the support wheels 34 so as to rotate the support wheels 34. The connecting gear 44 is disposed between the drive gears 42. In other words, the connecting gear 44 is arranged proximate to the center of the rotation shaft 43 along a longitudinal direction of the rotation shaft 43. Thus, power of the drive motor 41 is not concentrated on one of the drive gears 42, but, is more evenly transmitted to the drive gears 42. In the exemplary present embodiment, the connecting gear 44 is preferably directly connected to the motor gear 45 of the drive motor 41. However, a power transmitting unit may be installed between the connecting gear 44 and the drive motor 41 because of the positional and space restrictions for installing the drive motor 41.

The operation of the image forming apparatus having the above-described structure will now be described.

The electrostatic latent images are formed on the photosensitive bodies 11, 12, 13, and 14 via the charging units and the laser scanning units during a printing operation.

The electrostatic latent images on the photosensitive bodies 11, 12, 13, and 14 are developed with K, C, M, and Y color developers respectively supplied from the developing units 21, 22, 23, and 24.

The K, C, M, and Y color developers transferred to the photosensitive bodies 11, 12, 13, and 14 are overlapped on and/or transferred to the transfer belt 31. Here, the transfer belt 31 is fixed or integrally connected to the support unit 33 so as to rotate together with the support unit 33. Thus, the transfer belt 31 rotates in so that the color images are overlapped on and/or transferred to the transfer belt 31. As described above, since the transfer belt 31 rotates along with the support unit 33, the transfer belt 31 is less likely to slip or deviate. Thus, the color images can be accurately overlapped.

The transfer unit 30 preferably receives power via outer sides of the support wheels 34 and thus rotates. The transfer unit 30 is also rotatably supported by bearings 38 installed on the outer sides of the support wheels 34. Thus, operation errors occurring during rotation of a roller about a central axis, such as run-out, may be minimized.

Also, the transfer belt 31 may be rotated by a connection of gears. Thus, the transfer belt 31 can be driven at a constant speed. As a result, speed variations can be prevented from occurring due to transfer belt 31 thickness deviations. Also, the speed of the transfer belt 31 can be sensed relatively easily.

When the transfer unit 30 is designed, the transfer belt 31 can be constructed and modeled more easily.

The rotational speed of the transfer belt 31 is generally not affected by the load of the T2 roller 50 which contacts the transfer belt 31. Thus, normal transfer efficiency can be obtained.

As described above, in an image forming apparatus according to exemplary embodiment of the present invention, a transfer belt can be rotatably arranged in a substantially annular shape so as to rotate along with a support unit supporting the transfer belt. Thus, the transfer belt slippage and deviations can be prevented.

Also, rotational speed variations caused by deviations in thickness of the transfer belt can be prevented.

In addition, outer sides of support wheels supporting the transfer belt can be rotatably supported on the image forming apparatus and power can be transmitted to outer circumferential surfaces of the support wheels. Thus, errors in power transmission and rotation can be reduced.

Moreover, rotational speed of the transfer belt can be easily sensed.

As a result, precision of color images overlapped on and/or transferred to the transfer belt can be improved.

While the invention has been shown and described with reference to certain embodiments thereof, it will be understood by those skilled in the art that various changes in form and details may be made therein without departing from the spirit and scope of the invention as defined by the appended claims

What is claimed is:

1. A transfer unit of an image forming apparatus receiving an image from at least one or more photosensitive bodies and transferring the image to a printing medium, comprising:
a substantially annular transfer belt having first and second edges; and
a belt support unit configured to support and fix the edges of the transfer belt, and torotate along with the transfer belt.

2. The transfer unit of claim 1, wherein the belt support unit comprises:
a pair of spaced apart support wheels to which the respective edges of the transfer belt are fixed; and
a support shaft rotatably supporting the pair of support wheels.

3. The transfer unit of claim 2, further comprising:
at least one or more backup rollers which rotatably contact a rear surface of the transfer belt; and
a roller support supported by the belt support unit so as to support the backup rollers.

4. The transfer unit of claim 3, wherein the roller support comprises one end fixed to the support shaft and another end supporting the backup rollers so that the backup rollers rotate.

5. The transfer unit of claim 2, wherein gears are provided at outer circumferential surfaces of the pair of support wheels and supplied with a power from an external source.

6. The transfer unit of claim 2, wherein bearings are connected with the outer circumferential surfaces of the pair of support wheels.

7. The transfer unit of claim 2, wherein bearings are arranged between the support wheels and the support shaft.

8. The transfer unit of claim 2, wherein combining holes through which combiners connected with the pair of support wheels pass are arranged proximate to one of the edges of the transfer belt.

9. An image forming apparatus comprising:
a transfer unit comprising a transfer belt receiving an image from a photosensitive body and transferring the image to a printing medium and a belt support unit supporting first and second edges of the transfer belt so as to rotate along with the transfer belt; and
a driver rotating and driving the support unit.

10. The image forming apparatus of claim 9, wherein the belt support unit comprises:
a pair of spaced apart support wheels to which the edges of the transfer belt are connected; and
a support shaft rotatably supporting the pair of support wheels.

11. The image forming apparatus of claim 10, wherein the transfer unit comprises:
at least one or more backup rollers which rotatably contact a rear surface of the transfer belt; and
a roller support connected to the belt support unit so as to support the backup rollers so that the backup rollers rotate.

12. The image forming apparatus of claim 11, wherein the roller support comprises an end fixed to the support shaft and an other end supporting the backup rollers so that the backup rollers rotate.

13. The image forming apparatus of claim 11, wherein the backup rollers comprise:
T1 transfer rollers arranged so as to face the photosensitive body; and
T2 backup rollers facing a T2 transfer roller which transfer an image from the transfer belt to the printing medium.

14. The image forming apparatus of claim 10, wherein bearings are arranged between the support wheels and the support shaft.

15. The image forming apparatus of claim 10, wherein bearings are connected with outer circumferential surfaces of the pair of support wheels.

16. The image forming apparatus of claim 10, wherein the support wheels comprise:
disc-shaped wheel bodies connected with the support shaft;
support ribs arranged on outer sides of the wheel bodies which fix one of the edges of the transfer belt; and
gears arranged adjacent to the support ribs so as to receive a power from the driver.

17. The image forming apparatus of claim 10, wherein combining holes through which combiners connect with the pair of support wheels pass are arranged at one of the edges of the transfer belt.

18. The image forming apparatus of claim 10, wherein the driver comprises:
a pair of drive gears rotatably connected to the support wheels and driven; and
a drive motor which provides power to the drive gears.

19. The image forming apparatus of claim 18, wherein the driver further comprises:
a rotation shaft rotatably supporting the drive gears so as to rotate along with the drive gears; and
a connecting gear arranged proximate to a center of the rotation shaft so as to be positioned between the drive gears and connected to the drive motor to receive power.
